(19) United States
(12) Patent Application Publication
(10) Pub. No.: US 2026/0238862 A1
(43) Pub. Date: Aug. 13, 2026

(54) BIOMETRIC CAMERA MODULES, POWER DELIVERY, AND CABLE ARCHITECTURES FOR RETROFIT INTEGRATION

(71) Applicant: PopID, Inc., Diamond Bar, CA (US)

(72) Inventors: Anthony Lomelino, Diamond Bar, CA (US); John Miller, Diamond Bar, CA (US); Sean Olson, Diamond Bar, CA (US)

(21) Appl. No.: 19/639,954

(22) Filed: Apr. 6, 2026

Related U.S. Application Data
(63) Continuation-in-part of application No. 19/441,245, filed on Jan. 6, 2026.
(60) Provisional application No. 63/719,418, filed on Nov. 12, 2024.
(60) Provisional application No. 63/798,070, filed on May 1, 2025.
(60) Provisional application No. 63/816,910, filed on Jun. 3, 2025.

(51) Int. Cl. H04N 23/11; H04L 9/32; H04N 23/56

(52) U.S. Cl. CPC H04N 23/11; H04L 9/3268; H04N 23/56

(57) ABSTRACT

A biometric imaging module includes visible and near infrared capture, closed loop near infrared illumination with photodiode feedback and thermal derating, dual mode data I/O, and a power subsystem that negotiates voltage/current profiles with a host and provides over current protection and brown out recovery. A retrofit cable assembly integrates controlled impedance conductors, shielding, ESD/EMI mitigation, a tamper loop, and optional marker memory for power budgeting. The module performs secure device attestation before enabling high power illumination, reports tamper status, and supports signed firmware updates.

### CROSS REFERENCE TO RELATED APPLICATIONS

This application claims the benefit under 35 U.S.C. § 119(e) of the following U.S. Patent Applications, each incorporated herein by reference in its entirety: U.S. Non-Provisional application Ser. No. 19/441,245, filed on Jan. 6, 2026, entitled “CABLE CONFIGURATION FOR BIOMETRIC RETROFIT”; U.S. Provisional Application No. 63/798,070, filed May 1, 2025, entitled “BIOMETRIC CAMERA MODULE CAPABLE OF BOTH FACE AND PALM RECOGNITION FOR USE ON A KIOSK (OR OTHER POS SYSTEM)”; and U.S. Provisional Application No. 63/816,910, filed Jun. 3, 2025, entitled “DEVICES FOR ADDING BIOMETRIC CAPABILITIES TO PAYMENT TERMINALS.”

### BACKGROUND OF THE INVENTION

### Field

The disclosure relates to biometric imaging modules and electrical interconnects for adding or upgrading biometric capability to host devices. More particularly, the disclosure concerns RGB/IR camera modules, illumination and eye safety control, power delivery negotiation, cable harness designs, and tamper/ESD/EMI features suitable for retrofit into existing terminals and kiosks including those used for payment processing associated with the purchase of goods instore on online.

### Background

Automated online and retail payment systems, including those where the user identifies himself to check-in to a customer loyalty system, are well known in the prior art. In retail settings these systems involve the use of some type of a point of sale (POS) terminal. The POS terminal can take many forms, from a stand-alone terminal connected to a cash register, a tablet computer running a POS application, a grocery store self-checkout station, or terminals built into other devices like gas pumps, vending machines, ATMs, kiosks, and other variations.

Each such system has the ability to read a credit/debit card either by a user swiping the card through a magnetic card reading strip, a user inserting a card through the use of a card chip reader, or a user using a mobile phone capable of NFC-based payment, which can read a card that is in very close proximity to the terminal by interacting with the chip on the card. Further still, typically terminals can also interface using NFC technology to communicate with a payment application running on a smart phone such as Apple Pay or Google Pay. This allows a user to pay using their phone as a proxy for the credit card, by holding the phone near the POS terminal.

Online systems often require manual entry of credit card and other authentication information, but computing devices (especially mobile devices) can be equipped with card reading modules that allow for automatically entering credit card information in a manner similar to what is described above in reference to retail systems.

Once the payment information is entered in the POS system, payment processing proceeds in a manner well-known in the art.

Deployments of the above referenced systems that add biometric functions to existing terminals face practical integration constraints. The retrofit module must (i) power up safely from varied hosts; (ii) communicate over interfaces the host supports; (iii) manage near infrared (NIR) illumination within eye safety limits; (iv) survive electrostatic discharge (ESD) and electromagnetic interference (EMI) transients; (v) detect tampering through the cable run; and (vi) remain serviceable without opening the host enclosure, in addition to providing other capabilities associated therewith.

Prior art camera boards often assume a fixed host interface, cannot control for variation in illumination, and have short unshielded interconnects. These shortcomings lead to brown outs during high current LED operation, inconsistent eye safety enforcement, noisy image data, and undetected cable tampering. There is a need for a unified camera and cabling architecture that negotiates power, selects a data path automatically, enforces closed loop eye safety, and embeds tamper, ESD, and service features into the harness itself, that is capable of use with terminals and kiosks either as a retrofit option or as an OEM feature.

### SUMMARY OF THE INVENTION

In some embodiments, a biometric imaging module comprises an RGB sensor and an IR sensor (or a single device with both sensors and switchable filters), an illumination subsystem with NIR emitters and a photodiode based feedback loop, a microcontroller/system on chip (SoC) that executes capture and safety logic, a dual mode data interface (e.g., USB and a high speed serialized link), and a power subsystem that negotiates voltage/current profiles (with fallback to legacy 5 V), monitors temperature, and enforces over current protection.

A retrofit cable assembly integrates shielding, controlled impedance pairs or coax, tamper sense conductors, ESD suppression, and optional cable identification (e.g., marker memory) so the module can adjust power budgets for cable length/gauge. A secure element in the module performs device attestation to the host before enabling full power illumination. The module latches tamper events from the cable loop and can require re provisioning after certain tamper conditions.

In operation, the module negotiates power, selects a data path automatically, executes closed loop NIR control to keep irradiance below allowable levels, captures RGB/IR frames, and reports telemetry and tamper status. The cable embedded features improve robustness and safety without requiring changes to the host system's firmware or internal power rails.

### BRIEF DESCRIPTION OF THE DRAWINGS

FIG. 1 is a block diagram of a biometric imaging module showing sensors, ISP/SoC, illumination drivers with photodiode feedback, power management, secure element, and dual mode I/O.

### DETAILED DESCRIPTION OF THE INVENTION

### 1. Definitions

As used herein, “HSSL” denotes a high speed serialized link over coax or twisted pair with serializer/deserializer endpoints. “Module” denotes the imaging assembly described herein. “ost” denotes any device to which the module connects. “PD” denotes a dynamic negotiation of voltage and current profiles. “Legacy 5 V” denotes fixed 5 V supply without dynamic negotiation. “Tamper loop” denotes conductors that—when opened, shorted, or impedance shifted—indicate interference/tampering.

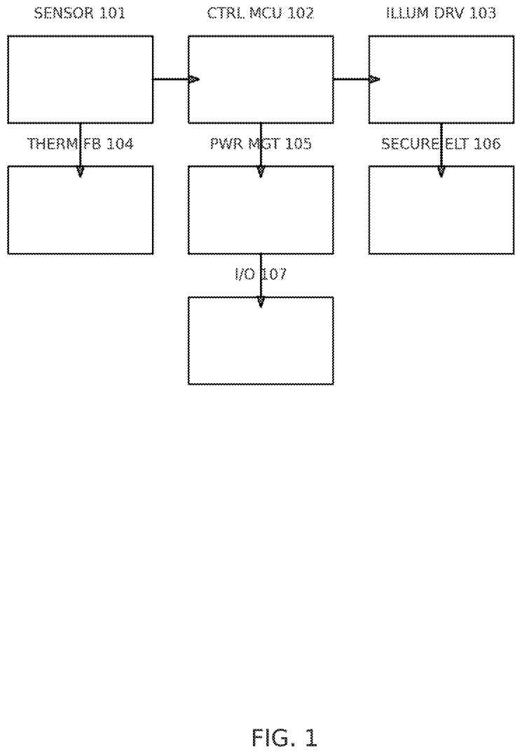

### 2. Module Architecture (FIG. 1)

The module includes: (i) a sensor 101 namely an RGB sensor and an IR sensor, or a single sensor with switchable illumination (for example, an RGB IR type) that can capture both visible and IR, while the modules switches the illumination between white/visible light and IR depending on the operating mode; (ii) optics appropriate to each modality (RGB or IR); (iii) an image signal processor (ISP) and/or SoC 102; (iv) an illumination subsystem 103 with NIR emitters (e.g., LEDs or vertical cavity surface emitting laser (VCSELs)) driven by constant current drivers; (v) a photodiode to measure emitted or reflected NIR 104; (vi) a power management unit (PMU) 105 with input protection, negotiation, and current monitoring; (vii) a security element 106 with unique keys; and (viii) a dual mode I/O 107 supporting USB (with optional Type C orientation/role detection) and HSSL.

### 3. Illumination and Eye Safety Control

A closed loop controller sets NIR drive current and duty cycle using photodiode readings, sensor exposure telemetry, ambient light readings, and module temperature. The controller enforces programmable irradiance ceilings, applies thermal derating via an NTC or on die sensor, and uses watchdog interlocks to force the driver off if feedback is lost or a limit is exceeded. For short range operation, a distance proxy (e.g., disparity between RGB and IR exposure values or a low cost ToF/proximity channel) further reduces NIR power when the subject is near.

In particular, the closed loop controller monitors various inputs such as photodiode levels (measuring NIR output), exposure telemetry from the image sensor, ambient light level, and module temperature, then sets the NIR drive current and duty cycle in response to ensure the modules stays within safe operating levels to avoid eye damage instead of relying predetermined levels which might not be accurate. Exposure telemetry refers to the module's ability to keep track of how much light exposure (for example, intensity×time) the sensor or user has received and reports that data as part of the eye-safety control loop described herein.

The module uses programmable irradiance ceilings (max allowed intensity), and thermal derating using a negative temperature coefficient (NTC) thermistor or on die temperature sensor so power is reduced as temperature rises, protecting both users and hardware. Thermal derating refers to the modules ability to intentionally reduces its maximum allowed output as temperature rises, to manage the risks described above as well to prevent components from becoming less safe or less reliable due to excessive heat.

Watchdog interlocks supervise the feedback signals and control loop such that if a sensor fails, communication is lost, or any safety limit is exceeded, the interlocks force the driver off or into a safe low power state.

In this manner, the module manages itself to prevent uncontrolled NIR emission in fault conditions, which is a common failure pattern in safety critical lighting and laser systems.

For short range operation, a distance estimate (from disparity between RGB and IR exposure values, or from a low cost time of flight/proximity channel) is used as a proxy for how close the subject is. When the subject is near, the controller further reduces NIR power, since eye safety and exposure risks are inversely proportional to the distance between the module and the subject shorter distances.

The module's thermal management includes an illumination driver that handles heat and how its allowed output is reduced as temperature rises, typically described by a predetermined graph (derating curve) of power vs. temperature. Below a threshold temperature the driver can supply full power; above that point, it gradually reduces current (dimming the illumination) and may eventually shut down at a defined maximum temperature to protect itself and the LEDs. All the forgoing designed to keep the module within safe operating temperatures in response to operating environment and the changing conditions therein. Optimal thermal management improves reliability and extends the operating lifetime of the module, especially because LEDs and driver components fail faster and lose performance when operated hot.

### 4. Data Interfaces

The module comprises both USB and HSSL data communication interfaces, wherein the module can select therebetween via a circuit or logic block that automatically decides whether data should travel over USB or over a faster dedicated serial link, depending on which option is working and supported.

On connection, a link selection state machine tests link integrity and automatically selects (a) USB (e.g., UVC streaming for frames, bulk/control for telemetry) or (b) HSSL, which carries pixel data and control over a single coax or a differential pair. The module can also operate in USB only or HSSL only configurations as well.

### 5. Power Delivery and Protection

On attachment, the PMU handles input power negotiation, protection, brown out behavior, and dynamic power limiting for the illumination system. The PMU negotiates available voltage/current profiles where supported (e.g., requesting a higher voltage like 9-12 V to give more headroom for the illumination driver if needed). If negotiation is unsupported, the module can default to legacy 5 V with current limiting, and can rely on current limiting to stay within what a basic 5 V port can safely supply.

The PMU includes inrush control, over current/short circuit protection, reverse polarity protection (if applicable), and brown out recovery logic that preserves state and resumes safely. The PMU can throttle illumination when the measured input drops under load.

Thus, the module can manage power in a wider variety of operating and load conditions to preserve functionality and integrity of the module.

### 6. Cable Assembly

The cable assembly comprises: (i) controlled impedance pairs or coax for data which uses twisted pairs or coaxial runs with defined impedance so high speed signals (USB, HSSL, etc.) meet signal integrity requirements and avoid reflections; (ii) power conductors sized for worst case current where the conductors have adequate gauge to safely carry the maximum expected current without excessive voltage drop or heating; (iii) a braided shield with 360° termination at connectors comprising a metallic braid around the cable that is bonded all the way around at the connectors for full circumference providing 360° shielding, improving EMI performance; (iv) transient voltage suppressor (TVS) devices and common mode chokes near each connector such that protection and filtering components at the ends clamp ESD/voltage spikes and suppress common mode noise currents on the data lines, reducing both emissions and susceptibility; (v) a tamper loop routed end to end which is an extra conductor loop that runs the length of the cable where breaking or shorting the conductor loop flags tampering or damage; (vi) optional marker memory indicating cable length/gauge/feature set wherein a small memory device in the cable can store ID, length, wire gauge, and feature information, allowing the host to detect cable type and capabilities automatically; and (vii) strain relief boots around the connectors help prevent mechanical stress and bending from damaging the conductors or shield at the cable-connector interface.

The assembly can be keyed to prevent mis mating. Shielding and choke placement are tuned to the link's spectral content. In particular, mechanical keying features on the connectors ensure the cable can only be plugged into the correct ports and orientation, avoiding electrical damage or signal errors, and the location and characteristics of shields and common mode chokes are optimized for the specific frequency range of the link, so they effectively attenuate noise at the relevant signal and interference frequencies. Common mode chokes comprise inductive components placed in series with differential or power lines that block common mode noise currents while letting the desired differential signal pass.

### 7. Tamper Detection

A dedicated tamper loop is biased and sampled by an MCU housing the tamper loop. Open, short, or impedance deviations beyond calibrated thresholds set a latched tamper flag stored in non-volatile memory. The module can degrade to a safe mode (e.g., no NIR, reduced data) or lock until re provisioned if tampering is detected. The tamper status is reported in telemetry on each session.

The tamper loop comprises a conductor routed end to end that the MCU drives (biases) and periodically measures. If the loop is opened, shorted, or its impedance drifts outside calibrated bounds, the MCU treats this as a tamper event. When such a condition is detected, the firmware sets a latched tamper flag in non-volatile memory, so the event persists across power cycles and cannot be cleared by just rebooting.

Additionally, if the is set, the module can switch to a safe or degraded mode, such as disabling NIR illumination and limiting data outputs, or fully locking until an authorized re provisioning or service procedure is performed. This reduces the risk that a physically compromised module could be misused or deliver unsafe output.

The tamper status is included in telemetry every time the module establishes a session with the host, so the host system or service backend can detect and log that the hardware has been opened or the cable compromised. Because the flag is latched and stored in non-volatile memory, tamper evidence remains available for audits, safety checks, or warranty decisions even long after the event occurred.

The general flow of the process described is set forth in the flow diagram shown in FIG. 6.

### 8. Secure Device Attestation

Prior to enabling high power illumination, the module performs a security check comprised of a challenge-response attestation with the host using a secure element that stores unique device keys and a certificate. If the attestation fails or the chain is untrusted, the module restricts operation (e.g., IR off, frames watermarked, limited frame rate).

In further details, the security check that proceeds before the use of bright IR/illumination, involves the use of a challenge-response attestation where the host sends a random challenge, and the module's secure element (which holds unique cryptographic keys and a certificate) computes a signed response that proves the module's identity and integrity. The host verifies the signature and certificate chain if the chain does not lead to a trusted root or verification fails, the device is treated as untrusted. High power illumination is gated on successful attestation, so IR or other bright emitters only run at full power when the module is proven genuine and in a known good state. If attestation fails or trust is uncertain, the module falls back to a predetermined restricted mode.

The secure element comprises a tamper resistant chip that stores the keys and runs cryptographic operations to prove a device's identity and integrity. In this manner, the module can link safety and any applicable regulatory compliance requirements to hardware authenticity such that only verified modules can drive the light at its maximum power level, reducing risks from counterfeit, modified, or compromised use.

### 9. Firmware Update and Serviceability (FIG. 10, FIG. 12)

Module security is provided through control process associated with firmware updates and service of the module. A signed image bootloader supports field updates via the active data link, and only accepts firmware images that carry a valid digital signature, so only authenticated code from the vendor can be installed and booted.

Firmware updates are atomic. The updates is written to an inactive partition and only switched active after verification. If the new firmware fails to boot or validate, the system automatically reverts to the prior partition so the device is not bricked and can revert to the prior firmware.

For additional security, a service header connector that exposes internal telemetry signals or a debug interface can optionally expose telemetry (voltage, current, temperature, tamper state) for diagnostics on a read only basis without opening the host enclosure. Making this telemetry read only and accessible without opening the host enclosure preserves safety/IP ratings while still allowing in field troubleshooting and health monitoring.

### 10. Variant: Remote Illumination Head (FIG. 11)

In some implementations, the NIR illumination head is physically separate and powered over the same coax (power over coax) or over a two wire constant current feed with remote sense. The main module retains sensing and safety control.

The remote illumination head contains the LEDs or other light emitters, optics, and possibly some local electronics, located away from the main controller/power electronics. The head can get its operating power through the coax, simplifying cabling and making the head smaller and easier to mount. Using power over coax for the head injects power onto the same coaxial cable that carries data or video, so the head can be powered without a separate power wire.

Thus, both electrical power and signals for the light source are sent over a single coaxial cable from a base unit to a physically separate illumination head.

Alternatively, a two wire constant current feed can be used to drives the NIR emitters at a controlled current, with remote sense used to measure voltage at the head and compensate for cable drops, keeping actual LED current within specifications.

### 11. ESD/EMI Considerations (FIG. 7)

Exposed connectors are hardened against ESD and EMI, and the cable shield is tied into the enclosure to improve noise immunity. High exposure interfaces include TVS elements placed at the connector, series resistors for edge rate control, and common mode chokes on differential pairs. The cable shield is terminated circumferentially to the module shell for improved immunity.

In this manner, high voltage spikes are diverted to ground before they can reach sensitive components. Series resistors provide edge rate control to slightly slow fast signal edges, reducing high frequency content and ringing, which lowers radiated and conducted EMI without breaking signal integrity. Common mode chokes on differential pairs filter common mode noise on high speed lines (such as USB or similar), improving EMI performance while leaving the desired differential signal largely unaffected. The cable shield is terminated circumferentially (360°) to the module shell, creating a low impedance, all around bond between shield and chassis instead of a single pigtail connection, which improves immunity by giving interference currents a short, controlled path to chassis, reducing the amount of noise that can couple into internal circuitry.

### 12. Implementation Notes

Nothing herein requires a particular vendor, lens, or sensor technology; values are implementation dependent. Mounting brackets, bezels, and terminal specific housings are handled in separate applications.

Aspects of the present disclosure may be described herein with reference to flowchart illustrations and/or block diagrams of methods, apparatuses (systems), and computer program products according to embodiments of the disclosure. It will be understood that some blocks of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

References to computer-readable media generally includes all types of computer-readable media, including magnetic storage media, optical storage media, and solid-state storage media. It should be understood that any software may be installed in and sold with the device. Alternatively, the software may be obtained and loaded into the device, including obtaining the software via a disc medium or from any manner of network or distribution system, including, for example, from a server owned by the software creator or from a server not owned but used by the software creator. The software can be stored on a server for distribution over the Internet, for example.

Computer-readable storage media (medium) can be accessed by a computing device and/or processor(s), and include volatile and non-volatile internal and/or external media that is removable and/or non-removable. For computing devices, the various types of storage media accommodate the storage of data in any suitable digital format. It should be appreciated by those skilled in the art that other types of computer readable medium can be employed such as zip drives, solid state drives, magnetic tape, flash memory cards, flash drives, cartridges, and the like, for storing computer executable instructions for performing the novel methods (acts) of the disclosed architecture.

The terminology used herein is for the purpose of describing particular aspects only and is not intended to be limiting of the disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

For purposes of this document, each process associated with the disclosed technology may be performed continuously and by one or more computing devices. Each step in a process may be performed by the same or different computing devices as those used in other steps, and each step need not necessarily be performed by a single computing device.

Although the subject matter has been described in language specific to structural features and/or methodological acts, it is to be understood that the subject matter defined in any appended claims is not necessarily limited to the specific features or acts described above. Rather, the specific features and acts described above are disclosed as example forms of implementing any claims.

What is claimed is:

1. A biometric imaging module comprising: an image sensor subsystem configured to capture visible light and near infrared image data; an illumination subsystem comprising one or more near infrared emitters and a constant current driver; a photodiode configured to sense near infrared output or reflection; a controller configured to adjust the constant current driver responsive to the photodiode and at least one of sensor exposure telemetry, ambient light, or module temperature; a power management unit configured to negotiate an input voltage and current profile with a host device and to provide over current protection and brown out recovery; a data interface configured to operate in at least one of a universal serial interface mode and a high speed serialized link mode; and a secure element configured to perform device attestation to the host; wherein the controller disables or reduces near infrared illumination when a safety threshold is exceeded or when device attestation is unsuccessful.

2. A cable assembly for a biometric imaging module, the cable assembly comprising: at least one controlled impedance differential pair or coaxial conductor for image data; power conductors sized for an illumination peak current; a braided shield with circumferential termination at a module side connector; at least one transient voltage suppressor and at least one common mode choke disposed proximate the module side connector; and a tamper loop extending between connectors and coupled to the module to report an open, short, or impedance deviation; wherein the cable assembly optionally includes a memory that stores at least cable length or gauge information readable by the module.

3. A method comprising: coupling a biometric imaging module to a host device via a cable; negotiating, by a power management unit of the module, an input voltage and current profile and, if negotiation is unavailable, enabling a legacy 5 volt mode with current limiting; selecting, by the module, a data path between a universal serial interface and a high speed serialized link; controlling, by a controller, a near infrared constant current driver responsive to a photodiode and at least one of sensor exposure telemetry, ambient light, or module temperature; capturing visible light and near infrared frames; reporting a tamper status derived from a tamper loop in the cable; and, upon a failed device attestation, operating in a restricted mode that disables high power near infrared illumination.

4. The module of claim 1, wherein the controller computes an illumination duty cycle and current setpoint that maintains an irradiance below a programmable ceiling and further reduces the setpoint responsive to a distance proxy derived from image exposure or a proximity sensor.

5. The module of claim 1, wherein the data interface automatically selects between the universal serial interface and the high speed serialized link based on link integrity testing.

6. The module of claim 1, wherein the power management unit requests at least one of a 9 volt or a 12 volt profile and throttles illumination when an input droop is detected.

7. The module of claim 1, further comprising an inrush limiting circuit and a reset less brown out recovery that preserves module configuration.

8. The module of claim 1, wherein the photodiode measurement is compensated for ambient light by subtracting a baseline obtained with illumination off.

9. The module of claim 1, wherein the secure element performs challenge-response using a device unique key and certificate and the controller enables high power illumination only after a successful verification.

10. The module of claim 1, further comprising non volatile memory that latches a tamper flag upon detection of an open, short, or impedance shift in the tamper loop and that requires re provisioning to clear the tamper flag.

11. The module of claim 1, wherein module temperature is measured by at least one of an NTC sensor or an on die temperature sensor, and the controller applies thermal derating to the illumination current.

12. The module of claim 1, wherein the module supports a remote illumination head powered over the high speed serialized link conductor via power injection circuitry or over a two wire constant current feed with remote sense.

13. The cable assembly of claim 2, wherein the shield is terminated with a 360 degree clamp ring to a conductive module shell.

14. The cable assembly of claim 2, further comprising ESD suppression devices disposed at both the module side connector and a host side connector.

15. The cable assembly of claim 2, wherein the memory stores at least one of: cable length, conductor gauge, or supported data path capability, and the module adjusts a power budget based on the stored information.

16. The cable assembly of claim 2, wherein the tamper loop comprises a twisted pair routed separately from the data pair to reduce crosstalk and is biased by the module to detect impedance changes.

17. The method of claim 3, further comprising, upon loss of photodiode feedback or controller watchdog timeout, forcing the illumination driver off and logging a fault event.

18. The method of claim 3, further comprising applying a firmware update to the module from the host, verifying a digital signature prior to activation, and reverting to a prior partition upon update failure.

19. The method of claim 3, wherein reporting the tamper status comprises transmitting a latched tamper flag until cleared by an authenticated provisioning message.

20. The module of claim 1, wherein the universal serial interface presents a video stream and a telemetry channel and the high speed serialized link carries both pixel data and control over a single physical medium.
